(19) United States
(12) Patent Application Publication
(10) Pub. No.: US 2016/0001529 A1
(43) Pub. Date: Jan. 7, 2016

(54) Large Format Polystyrene Panel

(71) Applicant: PROTOMAX PLASTICS LTD, Wiltshire (GB)

(72) Inventor: Nicholas Stillwell, Trowbridge (GB)

(21) Appl. No.: 14/373,764

(22) PCT Filed: Jan. 22, 2013
(86) PCT No.: PCT/GB2013/050134

§ 371 Date: Jul. 22, 2014

(30) Foreign Application Priority Data
Jan. 23, 2012 (GB) 1201039.3

(51) Int. Cl. B32B 27/06; B32B 27/32; B32B 5/20

(52) U.S. Cl. CPC B32B 27/065; B32B 5/20; B32B 27/325; B32B 2250/02; B32B 2250/24; B32B 2266/0214; B32B 2255/10; B32B 2479/00

(57) ABSTRACT

A panel for use in furniture and interior design applications includes a continuous outer skin formed of polystyrene or high impact polystyrene. The skin completely encapsulates a cellular plastic core. The core is formed from a heat activated foamable plastic particulate material. The area of the largest face of the panel is greater than 1 m². Both skin and filler material may be recycled plastics.

The present invention relates to a panel or board formed from polystyrene (PS) or high impact polystyrene (HIPS) with a solid, continuous outer skin and a cellular core structure. In particular, it relates to such a panel which is a large format, that is with a largest face of over 1 m² in area, and over 11 mm (and preferably over 14 mm) in thickness.

Current furniture making methods have moved away from solid wood to using composite materials such as MDF, chipboard and glass fibre, with coatings such as melamine or veneer to create a desired surface finish or colour.

Fibreboard and oriented strand board are commonly used in furniture and interior design. However, they are not resistant to moisture and therefore need to be painted or laminated as a secondary process to achieve an acceptable surface finish. This may include adding veneers or melamine coatings. This type of board therefore uses adhesives in its production, in both primary and secondary processes, and they are very difficult to recycle once laminated. Therefore, this type of board is limited to interior use in its primary form as it is not weatherproof.

Polystyrene and high impact polystyrene are known materials which are generally used in small, thin walled products such as coat hangers and yoghurt pots. The material is extruded as thin sheets which can then by thermoformed into a desired shape. It is possible using current extrusion technology to produce a solid polystyrene sheet of up to approximately 6 mm in thickness. However, such solid sheets of PS or HIPS are very brittle and have poor impact resistance. It is not possible using current technology to extrude a large format board of PS or HIPS which is over 11 mm in thickness. Even if it were possible to produce, a board made of solid PS/HIPS in a format of 2440×1220 mm (a typical industry standard size), with a thickness of say 19 mm (a typical desirable thickness in many applications in furniture and interior design) it would weigh approximately 55 kg, which is very heavy and therefore unsuitable for furniture and interior design applications.

Furthermore, PS/HIPS is a major polluter since little is currently recycled and discarded PS/HIPS does not biodegrade for hundreds of years and is resistant to photolysis. Since degradation of materials creates potentially harmful liquid and gaseous by-products that could contaminate groundwater and air, today's landfill sites are designed to minimise contact with air and water. However, air and water are necessary for degradation and therefore landfill design practically eliminates the degradation of waste.

Thus, current fibreboard products are difficult to recycle, require adhesives, secondary processes, suffer under moisture and have some health hazards associated with their processing. Hardwoods are very expensive, may have an environmental impact, and require various treatments before use. Solid plastic boards of over about 11 mm in thickness become very heavy, may still bend, and are expensive. Boards over 11 mm in thickness formed of PS or HIPS simply do not exist in the market at the current time.

The present invention provides a panel for use in furniture and interior design applications, comprising a continuous outer skin formed of polystyrene or high impact polystyrene completely encapsulating a cellular plastic core formed from a heat-activated foamable plastic particulate material, wherein the area of the largest face of the panel is greater than 1 m².

Preferably, the total thickness of the panel is greater than 11 mm.

Preferably, the outer skin comprises recycled PS or recycled HIPS. The core may also comprise mixed waste plastic. The core may also include reinforcement members.

The skin may be moulded to provide a surface texture and/or to incorporate a high temperature printed film.

The panel may incorporate at least one of anti-fungal agents, anti-bacterial agents and fire retardant agents to suit a given application.

The panel skin is preferably formed from a plastic particulate material applied directly to the surface of a heated mould.

The invention will now be described in detail, by way of example only, with reference to the accompanying drawings in which:

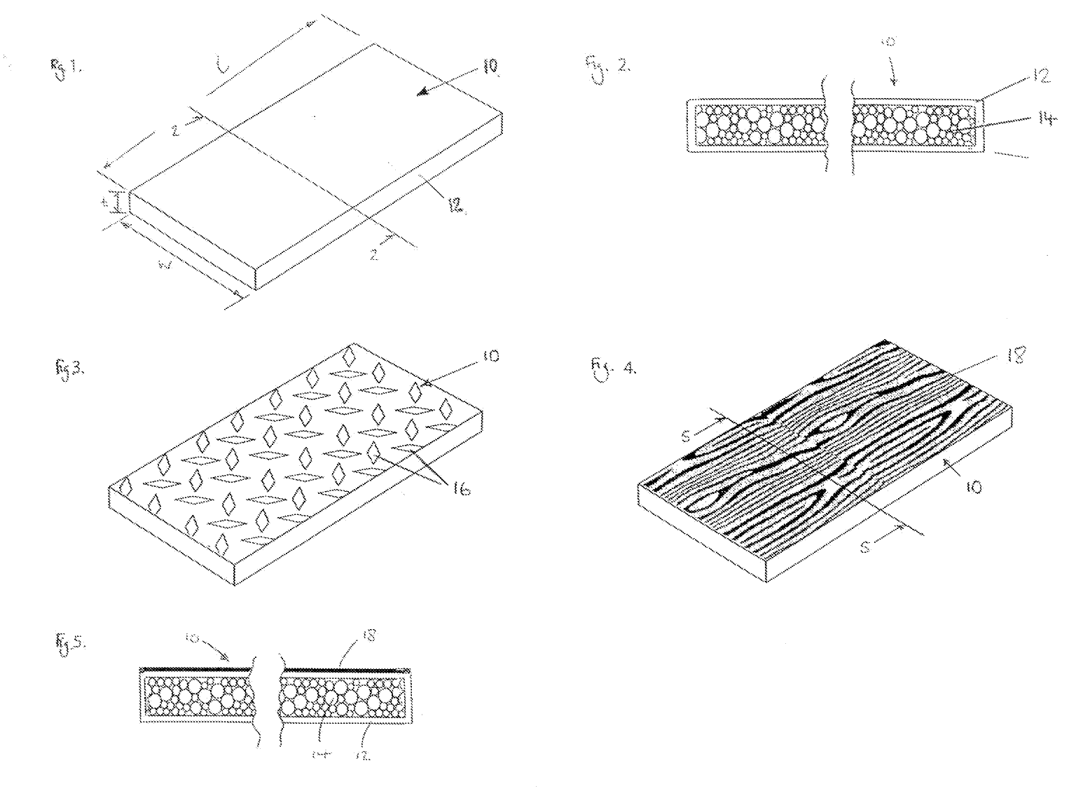

FIG. 1 is a perspective view of a panel in accordance with the present invention;

FIG. 2 is a cross-section of the panel of FIG. 1 along the line 2-2;

FIG. 3 is a perspective view of a second embodiment of the present invention formed with a non-slip surface;

FIG. 4 is a perspective view of the third embodiment of the present invention formed with surface graphics; and

FIG. 5 is a cross-sectional view of the panel of FIG. 4 along the line 5-5.

FIG. 1 illustrates a panel 10 in accordance with the present invention formed of PS or HIPS and with as length l, width w and thickness t. Typically, the length may be 2440 mm and width 1220 mm which is a typically industry standard size. In the present invention, the thickness is 11 mm or greater, and preferably over 14 mm.

The panel 10 comprises a continuous, solid outer skin 12 which extends over its entire surface with no openings, vent holes, injection cavities etc. As shown in FIG. 2, the skin 12 completely encloses a cellular core 14 which is very strong yet has a lower density and therefore reduced weight for a given volume as compared with the solid skin 12. The cellular core is formed from a heat-activated foamable plastic particulate material.

The panel 10 may be produced using a process such as that described in GB 2460838. Here, two heated, open female moulds are provided. Plastic particulate material is placed in both moulds and melts to form a skin lining each mould. An expandable filler material also in particulate form is added to one mould and the two moulds are brought together to form a closed mould cavity. Under the action of heat, the two skins bond together to create a single continuous skin which completely encapsulates the filler material, which expands to form the cellular core, filling the available volume within the continuous skin.

Alternatively, the panel 10 may be produced using a moulding machine as described in WO2011/114119. This uses a single heated female mould and a non complementary heated lid which may be brought together to form a mould cavity. As above, when the mould and lid are apart, plastic particulate material may be placed in contact with both in order to melt and form the plastic skin. Heat activated foamable plastic particulate filler material is placed in the female mould which is closed by the lid, to create a continuous skin completely encapsulating the filler. Heat from the moulds activates the filler to expand and fill the skin.

Thus, the panel 10 is preferably produced by a static mould process in which the mould remains in one place, rather than a process such as extrusion or rotomoulding or one requiring a mould to be moved by conveyers into an oven etc.

GB 2460838 describes the use of polyethylene (PE). This shrinks during production allowing easy removal of the finished product from the mould. PS and HIPS were previously considered unsuitable for this method because they undergo considerably less shrinkage. However, as there is less shrinkage, PS/HIPS panels can be formed to precise dimensions, for example for use as concrete formwork in place of plywood.

The skin 12 may be formed of virgin or recycled PS or HIPS, which is introduced into the mould in particulate form. The core 14 may be formed of virgin plastic, or mixed plastic waste, which may include PS or HIPS, which is also introduced into the mould in particulate form.

The continuous outer skin 12 is moisture proof, scratch resistant and stiff and is supported by the strong but lightweight cellular core 14.

The panel 10 can be formed to a desired shape and size depending on the moulds used. Therefore, while a rectangular panel is illustrated other shapes are possible. The panel 10 may also be cut, formed and fabricated by conventional methods to create different end products.

Colour may be added to the PS/HIPS skin 12 during manufacture to produce a panel 10 with a desired end-use colour. Therefore, painting or laminating are not required.

In a smooth mould, a very smooth outer surface of the skin 12 can be achieved. However, a textured or decorated surface can also be formed on the exterior of the panel 10. The walls of the moulds used may be textured to impart a given texture to the skin 12. For example, as in FIG. 3, a checker plate pattern of raised projections and/or depressions 16 can be moulded directly into the skin 12 to provide a non-slip surface on at least one face of the panel 10.

Surface decoration can also be provided by placing a high temperature printed film 18 in one or both moulds before forming the panel 10. For example, as shown in FIGS. 4 and 5 a wood grain effect can be provided on at least one face by a film 18 which bonds to the skin 12 during the moulding process. Therefore, veneers or laminates are not required.

The skin 12 and core 14 of the panel 10 may also incorporate materials and agents to improve the performance for particular customer applications. For example, fire retardants, anti-fungal agents or anti-bacterial agents and so on may be added.

Reinforcing members, such as a steel mesh, may be embedded within the core 14 during production to add strength and stiffness to the panel 10.

The thickness of the skin 12 of the panel 10 can be adjusted to suit the application. A thin skin 12 will give a lighter panel 10, whereas a thicker skin 12 will increase weight, strength and stiffness.

Thus, a panel in accordance with the present invention provides an environmentally friendly alternative to MDF, plywood, fibreboard and chipboard. The panel can be produced from waste materials and recycled again into another panel of the same type at the end of its life. In particular it can be provided from PS and HIPS which are seldom recycled at present. The panel also has improved performance in relation to the known alternative materials since it is moisture proof, scratch resistant, and strong yet lightweight. Different surface finishes can be incorporated at the primary production stage so that secondary processes are unnecessary.

1. A panel for use in furniture and interior design applications, comprising a continuous outer skin formed of polystyrene or high impact polystyrene completely encapsulating a cellular plastic core formed from a heat activated foamable plastic particulate material, wherein the area of the largest face of the panel is greater than 1 mu 2.

2. A panel as claimed in claim 1, wherein the total thickness of the panel is greater than 11 mm.

3. A panel as claimed in claim 1, wherein the continuous outer skin is formed of recycled polystyrene or recycled high impact polystyrene.

4. A panel as claimed in claim 1, wherein the core comprises mixed waste plastic.

5. A panel as claimed in claim 1, wherein the core includes reinforcement members.

6. A panel as claimed in claim 1, wherein the skin is moulded to provide a surface texture.

7. A panel as claimed in claim 1, wherein the skin incorporates a high temperature printed film.

8. A panel as claimed in claim 1, incorporating at least one of anti-fungal agents, anti-bacterial agents and fire retardant agents.

9. A panel as claimed in claim 1, wherein the skin is formed from a plastic particulate material applied directly to the surface of a heated mould.

10. (canceled)
